(19) United States
(12) Patent Application Publication
(10) Pub. No.: US 2022/0267026 A1
(43) Pub. Date: Aug. 25, 2022

(54) DRONE LANDING SYSTEM

(71) Applicant: VORASKY Corp., Seoul (KR)

(72) Inventor: Dong Hwan LEE, Hwaseong-si (KR)

(21) Appl. No.: 17/743,791

(22) Filed: May 13, 2022

Related U.S. Application Data
(63) Continuation of application No. PCT/KR2020/015616, filed on Nov. 9, 2020.

(30) Foreign Application Priority Data
Nov. 15, 2019 (KR) 10-2019-0146922
May 28, 2020 (KR) 10-2020-0064534

(51) Int. Cl. B64F 1/36; B64C 39/02; B64C 19/00; G05D 1/00; G05D 1/10

(52) U.S. Cl. CPC B64F 1/36; B64C 39/024; B64C 19/00; G05D 1/0038; G05D 1/101; B64C 2201/123

(57) ABSTRACT

Disclosed herein is a drone landing system. The drone landing system can provide precise landing guidance for drones through detection of X/Y distances and a Z distance of a drone from a center point of a station using an X/Y-axis camera and a Z-axis camera disposed on the station and through automatic or manual control over the drone using a controller.

### CROSS-REFERENCE TO RELATED APPLICATIONS

This application is a bypass-continuation of International PCT application No. PCT/KR2020/015616 filed on Nov. 9, 2020, which claims priority to Republic of Korea Patent Application No. 10-2019-0146922 filed on Nov. 15, 2019 and Republic of Korea Patent Application No. 10-2020-0064534 filed on May 28, 2020, which are incorporated by reference herein in their entirety.

### TECHNICAL FIELD

The present invention relates to a drone landing system and, more particularly, to a drone landing system that can provide precise landing guidance for drones through detection of X/Y distances and a Z distance of a drone from a center point of a station using an X/Y-axis camera and a Z-axis camera disposed on the station and through automatic or manual control over the drone using a controller.

### BACKGROUND ART

Drones are drawing attention in various fields including military and industrial applications due to the ability to easily collect ground and aerial information at high altitudes without involving any risk to users and without being noticed by others.

Drones are different from radio-controlled aircraft directly controlled by an external pilot in that the drones can fly autonomously. In addition, the drones are basically recoverable after completing a task and can repeatedly perform tasks, unlike a missile which once launched, will be destroyed upon hitting a target.

Today's drones have a very high degree of freedom, including the ability to measure their own position, speed, and posture, to autonomously create an optimal route for a given task, to fly along the route, and to self-diagnose and respond to failures. Recently, the drones are used for various private and commercial purposes, apart from military purposes. For example, the drones can perform various tasks, such as photographing a place inaccessible to humans, weather observation, sports broadcasting, investigative reporting, and unmanned delivery services.

However, although the drones can autonomously create an optimal route and fly along the route, it is still a user's responsibility to determine an emergency situation that occurs during flight and it is very important to properly respond to such an emergency situation.

In particular, problems occur mainly when a drone takes off or lands. Unlike in the air, there are many risk factors on the ground. Accordingly, failure to respond promptly to rapidly changing circumstances on the ground can cause a drone to crash during take-off or landing. Such a drone crash incident can lead to secondary collision, such as collision with a person or object on the ground, which results in loss of life or property.

Korean Patent Laid-open Publication No. 10-2018-0096350 (publication date: 2018 Aug. 29) discloses a portable drone landing guidance device which guides landing of a drone by securing a clear view using a panel including a light emitting unit. However, this device has a problem in that a user has to manually control the drone with the naked eye.

### SUMMARY

Embodiments of the present invention are conceived to solve such problems in the art and it is an object of the present invention to provide a drone landing system that can provide precise landing guidance for drones by determining X/Y-axis values and a Z-axis value of a drone through a display unit displaying images captured by an X/Y-axis camera and a Z-axis camera disposed on a station and by performing precise automatic or manual control over the drone using a controller

In accordance with an aspect of the present invention, there is provide a drone landing system including a drone, a station, and a controller, wherein the station includes: a landing pad on which the drone lands; an X/Y-axis camera disposed at a center of the landing pad, capturing a bottom-view image of the drone, and detecting a horizontal position of the drone; and a Z-axis camera disposed on the station, capturing a side-view image of the drone, and detecting a height of the drone from the ground.

The controller may include: a display unit displaying the images captured by the X/Y-axis camera and the Z-axis camera; an automatic control unit automatically controlling X/Y/Z-axis values of the drone based on the position and height of the drone detected by the X/Y-axis camera and the Z-axis camera; and a manual control unit manually controlling the X/Y/Z-axis values of the drone.

The automatic control unit may be automatically operated when the manual control unit is not in operation.

The drone may include a top-view camera disposed at a lower end thereof and capturing a top-view image of the station, and the controller may further include a top-view display unit displaying the image captured by the top-view camera.

With the X/Y-axis camera and the Z-axis camera detecting X/Y distances and a Z distance of the drone from a center point of the station and the display unit displaying the X/Y distances and Z distance of the drone, the drone landing system according to the present invention can precisely guide landing of the drone.

The drone landing system according to the present invention can precisely guide landing of the drone by automatically or manually controlling the drone depending on the distance from the center point of the station to the drone.

With the top-view camera disposed on the drone to recognize a letter or pattern marked on the station, the drone landing system according to the present invention can precisely guide landing of the drone by controlling the drone to move to a correct position.

### BRIEF DESCRIPTION OF DRAWINGS

FIG. 1 is a schematic view of a drone landing system according to the present invention.

FIG. 2 is a schematic view of another embodiment of a station shown in FIG. 1.

FIG. 3 is a schematic view of a display unit of a controller shown in FIG. 1.

FIGS. 4A through 5B are schematic views illustrating exemplary operation of the drone landing system according to the present invention.

FIGS. 6A through 6D are schematic views illustrating exemplary operation of the drone landing system according to another embodiment of the present invention.

FIG. 7 is a flowchart of an automatic control method using an automatic control unit of the drone landing system according to the present invention.

FIG. 8 is a flowchart of a manual control method using a manual control unit of the drone landing system according to the present invention.

### DETAILED DESCRIPTION OF EMBODIMENTS

Hereinafter, embodiments of the present invention will be described with reference to the accompanying drawings. It should be understood that the embodiments are provided for illustration only and are not to be construed in any way as limiting the present invention. In addition, description of known functions and constructions which may unnecessarily obscure the subject matter of the present invention will be omitted.

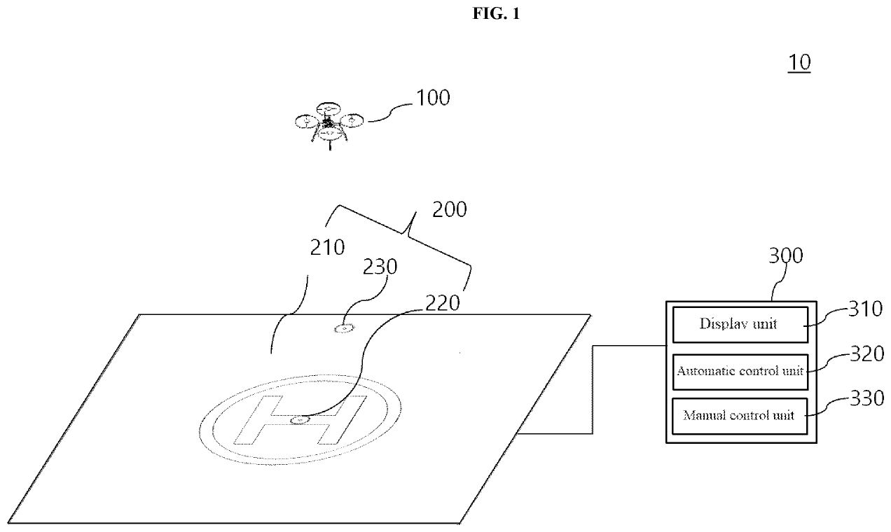

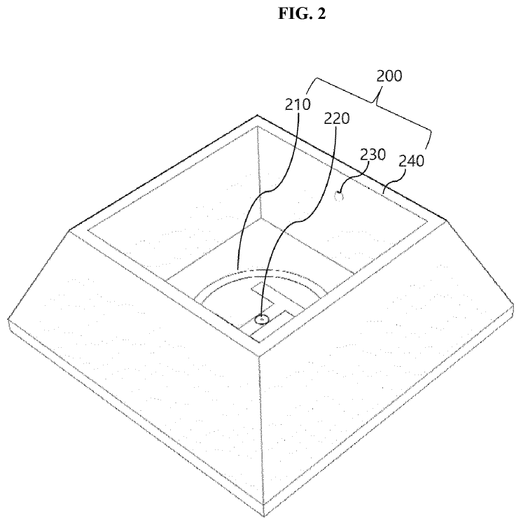

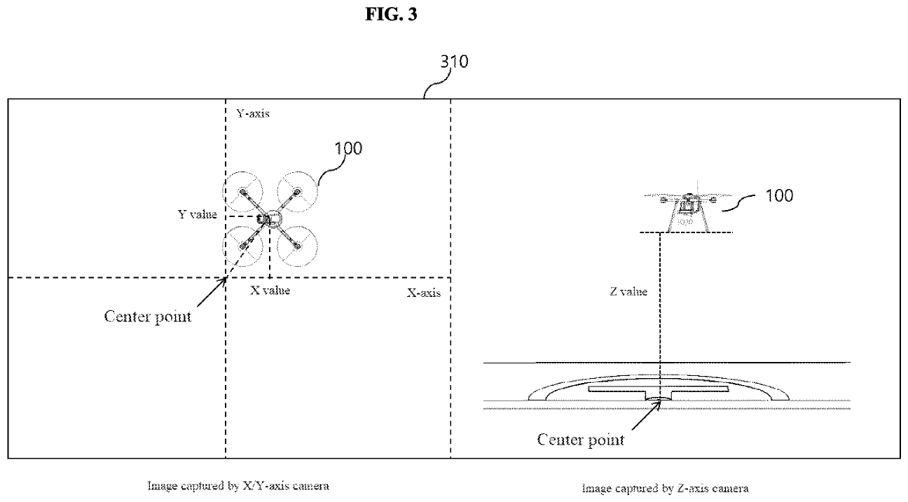

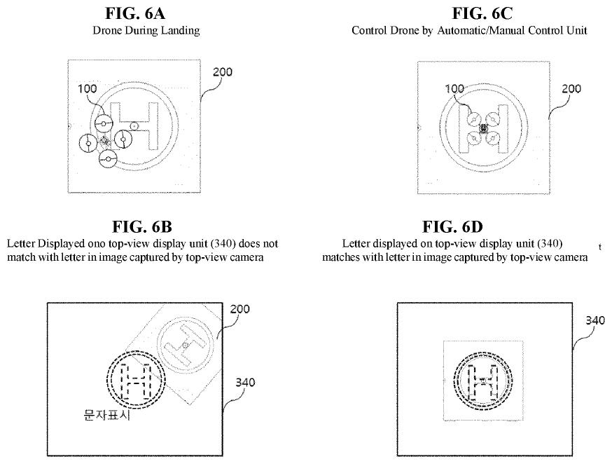

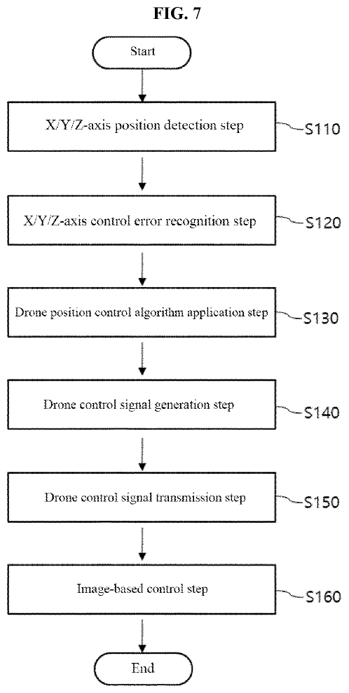

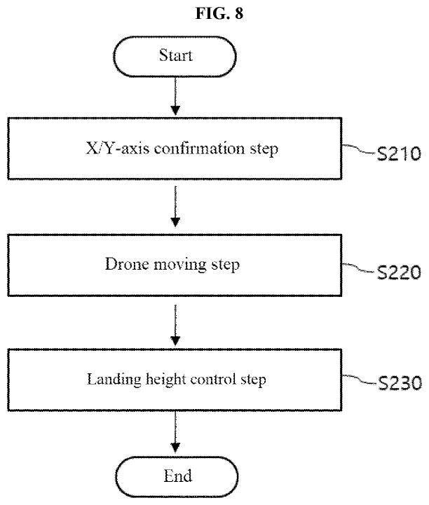

FIG. 1 is a schematic view of a drone landing system according to the present invention, FIG. 2 is a schematic view of another embodiment of a station shown in FIG. 1, FIG. 3 is a schematic view of a display unit of a controller shown in FIG. 1 and FIGS. 4A through 5B are schematic views illustrating exemplary operation of the drone landing system according to the present invention, FIG. 6 is a schematic view illustrating exemplary operation of the drone landing system according to another embodiment of the present invention, FIG. 7 is a flowchart of an automatic control method using an automatic control unit of the drone landing system according to the present invention, and FIG. 8 is a flowchart of a manual control method using a manual control unit of the drone landing system according to the present invention.

Referring to FIG. 1, a drone landing system 10 according to the present invention may include a drone 100, a station 200, and a controller 300.

The drone 100 may include a main body, multiple arms extending from respective sides of the main body to generate thrust, and landing gear disposed on the main body or the multiple arms. The drone 100 may fly in the sky by manual control by an operator on the ground or by automatic control by a flight program loaded on the drone 100. The station 200 may have a flat surface having a predetermined area to be placed on the ground or a structure. The station 200 may protect the drone 100 making a landing after completing a flight from obstacles. The controller 300 may protect the drone 100 by guiding the drone 100 to land safely through control over the drone 100 and the station 200.

The drone 100 may further include an ultrasonic sensor (not shown), a vision sensor (not shown), a barometric pressure sensor (not shown), and a GPS sensor (not shown).

The ultrasonic sensor (not shown) is a sensor that measures a distance from the drone 100 in flight to the ground or an object, and may calculate the distance by measuring the time it takes between emission of ultrasonic waves and detection of echoes thereof. The vision sensor (not shown) is a sensor that generates an image from the viewpoint of the drone 100 in flight and analyzes the image to determine the presence of an obstacle, and may prevent a collision with the obstacle. The barometric pressure sensor (not shown) is a sensor that measures an altitude of the drone 100 in flight by measuring atmospheric pressure depending on height from sea level. Preferably, the barometric pressure sensor is used in combination with the GPS sensor, rather than used alone, to precisely measure the altitude of the drone 100 over a wide space. The GPS sensor (not shown) is a sensor that measures the real-time location coordinates and altitude of the drone 100 in flight using signals from artificial satellites. Specifically, the GPS sensor may measure the location coordinates and altitude of the drone 100 based on coordinate values obtained through calculation of a distance between a GPS satellite and a GPS receiver.

The station 200 may include a landing pad 210, an X/Y-axis camera 220, and a Z-axis camera 230.

The landing pad 210 may be formed in a board shape having a predetermined area and may be disposed on a bottom of the station 200 to allow the drone 100 to land thereon. The landing pad 210 is provided at a center thereof with a center point that serves as a reference point to detect a distance to the drone 100. In addition, the landing pad 210 may have an upper surface supporting the landing gear of the drone 100 and a lower surface adjoining the ground or the structure to support the station 200 and compensate for unevenness of the ground or the structure so as to allow the landing gear of the drone 100 to rest on the upper surface of the landing pad 210.

The X/Y-axis camera 220 may be disposed at the center point of the landing pad 210 to capture a bottom-view image of the drone 100, to detect X/Y distances of the drone 100 from the center point of the station 200, and to determine real-time changes in X/Y distances of the drone 100, thereby enabling precise landing guidance.

The Z-axis camera 230 may be provided to the station 200 to capture a side-view image of the drone, to detect a Z distance of the drone 100 from the center point of the station 200, and to determine real-time changes in Z distance of the drone, thereby enabling precise landing guidance.

Referring to FIG. 2, the station 200 may further include a windbreak wall 240.

The windbreak wall 240 may extend vertically from an edge of the landing pad 210 to a predetermined height to surround the landing pad 210 so as to protect the drone 100 from external obstacles or wind shear. The Z-axis camera 230 may be disposed on the windbreak wall 240. When the drone 100 descends to a predetermined altitude above the station 200, the windbreak wall 240 may reduce wind forces on the drone 100, thereby allowing precise landing control. In addition, the windbreak wall 240 may have a slanted outer surface to diffuse the force of incoming wind to protect the windbreak wall 240 therefrom.

In addition, the windbreak wall 240 may include a rigid or flexible stationary structure and a porous structure such as a mesh. When the windbreak wall 240 has a porous structure, the windbreak wall 240 allows passage of a certain amount of wind into the station 200 and thus can be prevented from damage due to strong wind forces.

Referring again to FIG. 1 and FIG. 3, the controller 300 may include a display unit 310, an automatic control unit 320, and a manual control unit 330.

Referring to FIG. 3, the display unit 310 may display images captured by the X/Y-axis camera 220 and the Z-axis camera 230. The display unit 310 may simultaneously display an image captured by the X/Y-axis camera 220 and an image captured by the Z-axis camera 230 on separate parts thereof, wherein the X/Y distances of the drone 100 from the center point of the station 200 and the X- and Y-axes centered on the center point of the station 200 are displayed on the image captured by the X/Y-axis camera 220 and the Z distance of the drone 100 from the center point of the station 200 and the Z-axis centered on the center point of the station 200 are displayed on the image captured by the Z-axis camera 230, thereby allowing accurate determination of the position of the drone 100 with respect to the center point of the station 200.

The automatic control unit 320 may automatically control landing of the drone 100 by automatically generating a control signal for controlling the drone 100 based on the X/Y/Z distances of the drone 100 detected by the X/Y-axis camera 220 and the Z-axis camera 230. The automatic control unit 320 may be operated to control the drone 100 from the time the drone 100 reaches a predetermined altitude above the center point of the station. Preferably, the automatic control unit 320 controls the drone 100 to guide landing of the drone 100 from the time the drone 100 reaches an altitude of 100 m above the center point of the station.

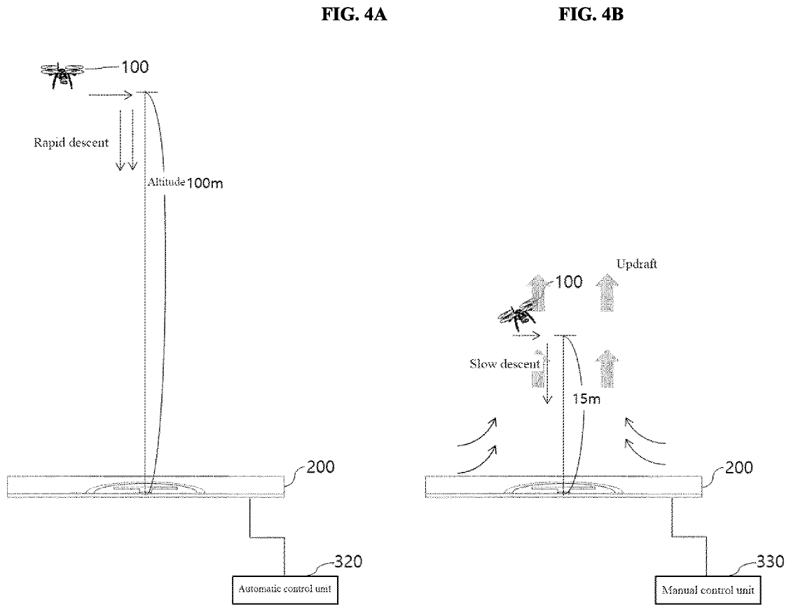

For example, referring to FIG. 4A, autonomous flight of the drone 100 may be terminated when the drone 100 reaches an altitude of 100 m above the center point of the station 200 after flying over a target zone under the control of a flight program loaded thereon. At this time, the drone landing system 10 may start landing guidance of the drone 100. First, the X/Y-axis camera 220 and the Z-axis camera 230 of the station 200 may capture images of the drone 100 to detect the X/Y/Z distances of the drone 100 from the center point of the station 200. The detected X/Y/Z distances may be displayed on the display unit 310 of the controller 300. Then, the automatic control unit may guide landing of the drone 100 by controlling the drone 100 to descend rapidly toward the center point of the station 200.

The manual control unit 330 may be operated to manually generate a control signal for controlling the drone 100 to control the X/Y/Z positions of the drone 100. The manual control unit 330 may control the drone 100 from the time the drone 100 reaches a predetermined distance from the station 200, specifically 15 m above the landing pad 210. The manual control unit 330 may include an input device such as a joystick, a keypad, and a touchpad to guide landing of the drone 100 through precise manual control over the drone 100.

For example, referring to FIG. 4B, the manual control unit 330 may be operable when the drone 100 descending rapidly under the control of the automatic control unit 320 reaches 15 m above the landing pad 210. Using the manual control unit 330, an operator can precisely guide landing of the drone 100 by moving the drone 100 to the center point of the station 200 through precise control over the X/Y/Z positions of the drone 100 while the drone 100 descends slowly.

In addition, when the station 200 is provided with the windbreak wall, the manual control unit 330 may control the drone 100 from the time the drone 100 reaches a predetermined distance from an upper end of the windbreak wall 240, specifically 5 m above the upper end of the windbreak wall 240.

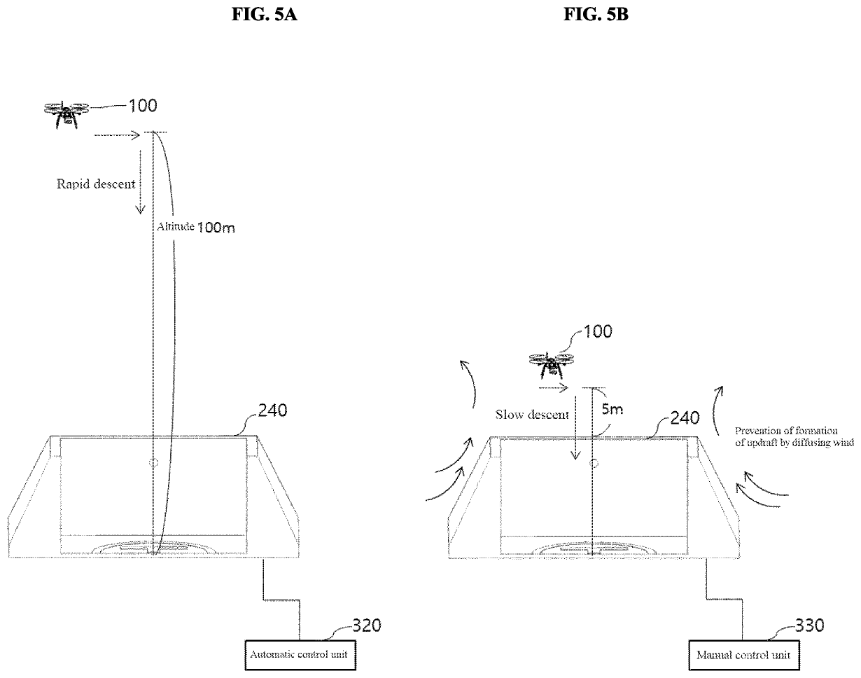

For example, referring to FIG. 5A, autonomous flight of the drone 100 may be terminated when the drone 100 reaches an altitude of 100 m above the center point of the station 200 after flying over a target zone under the control of a flight program loaded thereon. At this time, the drone landing system 10 may start landing guidance of the drone 100. First, the X/Y-axis camera 220 and the Z-axis camera 230 of the station 200 may capture images of the drone 100 to detect the X/Y/Z distances of the drone 100 from the center point of the station 200. The detected X/Y/Z distances may be displayed on the display unit 310 of the controller 300. Then, the automatic control unit may guide landing of the drone 100 by controlling the drone 100 to descend rapidly toward the center point of the station 200.

In addition, referring to FIG. 5B, the manual control unit 330 may be operable when the drone 100 descending rapidly under the control of the automatic control unit 320 reaches 5 m above the upper end of the windbreak wall 240. Using the manual control unit 330, an operator can precisely guide landing of the drone 100 by moving the drone 100 to the center point of the station 200 through precise control over the X/Y/Z positions of the drone 100 while the drone 100 descends slowly.

Here, referring to FIG. 4B, when the station 200 includes only the landing pad 210, there is a risk that the drone 100 will crash during landing due to wind shear (a sudden, drastic change in wind velocity and/or direction) caused by an updraft or a downdraft formed when a strong wind near a ground surface occupied by the station 200 hits irregular terrain features. Conversely, referring to FIG. 5B, when the station 200 further includes the windbreak wall 240, the slanted outer surface of the windbreak wall 240 can diffuse the effects of wind shear to reduce wind forces on the drone 100 descending from the sky, thereby preventing crash of the drone 100 while ensuring precise landing control without wind interference.

In addition, the automatic control unit 320 of the controller may be automatically operated when the manual control unit 330 is not in operation. Alternatively, the manual control unit 330 and the automatic control unit 320 may be operated simultaneously.

Referring again to FIG. 4A to FIG. 5B, the automatic control unit 320 controls the drone 100 to descend rapidly toward the center point of the station 200. When the drone 100 reaches a predetermined distance from the upper end of the windbreak wall 240, the manual control unit 330 is operated to move the drone 100 to the center point of the station 200 through precise control over the X/Y/Z positions of the drone 100. After the manual control unit 330 completes the operation, the manual control unit 330 guides the drone 100 to land accurately on the center point of the station 200 while controlling the drone 100 to descend slowly.

For example, when automatic flight of the drone 100 is terminated at an altitude of 100 m above the center point of the station 200, the X/Y-axis camera 220 and the Z-axis camera 230 capture images of the drone 100 to detect the X/Y/Z distances of the drone 100 and then the automatic control unit 320 controls the drone 100 to descend rapidly toward the center point of the station 200 based on the detected X/Y/Z distances. When the drone 100 reaches 15 m above the landing pad 210 or 5 m above the upper end of the windbreak wall 240, the automatic control unit 320 stops rapid descent of the drone 100 and the manual control unit 330 is operated to move the drone 100 to the center point of the station 200 through control over the X/Y/Z positions of the drone 100. After the manual control unit 330 completes the operation, the automatic control unit 320 guides the drone 100 to land accurately on the center point of the station 200 while controlling the drone 100 to descend slowly.

Alternatively, when the drone 100 descending rapidly toward the center point of the station 200 under the control of the automatic control unit 320 reaches a predetermined distance from the landing pad 210 or the upper end of the windbreak wall 240, the manual control unit 330 is operated to move the drone 100 to the center point of the station 200 through precise control over the X/Y/Z positions of the drone 100 while the automatic control unit 320 controls the drone 100 to descend slowly, thereby providing precise landing guidance.

For example, when automatic flight of the drone 100 is terminated at an altitude of 100 m above the center point of the station 200, the X/Y-axis camera 220 and the Z-axis camera 230 capture images of the drone to detect the X/Y/Z distances of the drone 100 and then the automatic control unit 320 controls the drone 100 to descend rapidly toward the center point of the station 200 based on the detected X/Y/Z distances. When the drone 100 reaches 15 m above the landing pad 210 or 5 m above the upper end of the windbreak wall 240, the manual control unit 330 is operated to move the drone 100 to the center point of the station 200 by simultaneously changing the X/Y/Z distances of the drone 100 through control over the X/Y/Z positions of the drone 100 while the automatic control unit 320 controls the drone 100 to descend slowly, thereby providing precise landing guidance.

Referring to FIGS. 6A through 6D, the drone 100 may further include a top-view camera (not shown) and the controller 300 may further include a top-view display unit 340.

The top-view camera may be disposed at a lower end of the drone 100, and may capture a top-view image of the station 200 to recognize a letter or pattern marked on the landing pad 210 of the station 200. The top-view display unit 340 may display the image captured by the top-view camera (not shown), and may display the letter or pattern marked on the landing pad 210 of the station 200. When the letter or pattern in the image captured by the top-view camera (not shown) does not match with the letter or pattern displayed on the top-view display unit 340, the automatic control unit 320 or the manual control unit 330 of the controller 300 may control the drone 100 to move to a desired position at which the letter or pattern in the image captured by the top-view camera matches with the letter or pattern displayed on the top-view display unit 340, thereby providing precise landing guidance.

For example, referring to FIG. 6A and FIG. 6B, when the drone 100 is off-center with respect to the center point of the station 200 during landing, the letter displayed on the top-view display unit 340 does not match with the letter on the station 200 in the image captured by the top-view camera (not shown). Referring to FIG. 6C and FIG. 6D, the automatic control unit 320 or the manual control unit 330 of the controller 300 may guide the drone 100 to the center point by turning the descending drone 100 clockwise or counterclockwise until the letter displayed on the top-view display unit 340 matches with the letter in the image captured by the top-view camera (not shown), thereby allowing precise landing control of the drone 100.

Referring to FIG. 7, an automatic control method 100 using the automatic control unit 320 for guiding landing of the drone 100 may include an X/Y/Z-axis position detection step S110, an X/Y/Z-axis control error recognition step S120, a drone position control algorithm application step S130, a drone control signal generation step S140, a drone control signal transmission step S150, and an image-based control step 160.

First, when the drone 100 completes a predetermined autonomous flight task, the automatic control unit 320 of the controller 300 is operated to guide landing of the drone 100. Here, the automatic control unit 320 may guide landing of the drone 100 from the time the drone 100 reaches a predetermined altitude.

In the X/Y/Z-axis position detection step S110, X/Y/Z-axis positions of the drone 100 with respect to the station 200 are detected using the X/Y-axis camera 220 and the Z-axis camera 230 of the station 200 and the ultrasonic sensor, the barometric pressure sensor, and the GPS sensor of the drone 100. In the X/Y/Z-axis position detection step S110, the X/Y/Z-axis positions of the drone 100 with respect to the center point of the station 200 may be precisely detected and measured.

In the X/Y/Z-axis control error recognition step S120, an error is calculated between a target value to which the drone 100 is to be controlled by the automatic control unit 320 and a value measured in the X/Y/Z-axis position detection step S110. Based on the calculated error, the automatic control unit 320 may calculate a control value required for control. Here, the target value may be the center point of the station 200.

In the drone position control algorithm application step S130, the automatic control unit 320 applies a position control algorithm for automatic control over the drone 100. The position control algorithm may include an On/Off position control algorithm and a proportional-integral-differential (PID) position control algorithm. Here, the On/Off position control algorithm is a method of turning a control input on or off until reaching a target value, and the PID position control algorithm is a method of measuring an input value defined by a control object, calculating an error between the input value and a predetermined target value through comparison of the input value with the target value, calculating a control value required for control using the calculated error, and calculating a value input to the control object using the control value as feedback. Here, the PID position control algorithm may automatically control the drone 110 using the value measured in the X/Y/Z-axis position detection step and the center point of the station 200 as the input value and the target value, respectively.

In the drone control signal generation step S140, the automatic control unit 320 generates signals for controlling the drone 100 based on a value calculated in the drone position control algorithm application step S130. Here, the signals for controlling the drone 100 may include a pulse width modulation (PWM) signal, a pulse position modulation (PPM) signal, an SBUS signal, and the like.

In the drone control signal transmission step S150, the automatic control unit 320 transmits the signals generated in the drone control signal generation step S140 to the drone 100. The drone 100 may automatically descend towards the center point of the station 200 in response to the signals transmitted from the automatic control unit 320.

In the image-based control step, the automatic control unit 320 controls the position of the drone 100 by applying an image-based control algorithm based on images captured by the X/Y-axis camera 220 and the Z-axis camera 230 of the station 200. Here, the automatic control unit 320 may automatically control landing of the drone 200 while guiding the drone to the center point of the station 200 along the X-, Y-, and Z-axes displayed on the display unit 310.

Referring to FIG. 8, a manual control method S200 using the manual control unit 330 for guiding landing of the drone 100 may include an X/Y-axis confirmation step S210, a drone moving step S220, and a landing height control step S230.

When the drone 100 descending toward the station 200 under automatic control by the automatic control unit 320 reaches a predetermined distance above the landing pad 210 or the upper end of the windbreak wall 240, the drone 100 may be guided to land under manual control using the manual control unit 330.

In the X/Y-axis confirmation step S210, images of the drone 100 captured by the X/Y-axis camera 220 and the Z-axis camera 230 of the station 200 are confirmed through the display unit 310. Specifically, the degree of deviation of the drone 100 from the center point of the station 200 may be ascertained based on the X/Y/Z distances of the drone 100 from the center point of the station 200, which are displayed on the display unit 310, and the X-, Y-, and Z-axes, which are displayed on the display unit 310.

In the drone moving step S220, the manual control unit 330 is operated to move the drone 100. Specifically, the drone 100 may be accurately moved to the center point of the station 200 along the X- and Y-axes by a control signal generated by operation of the manual control unit 330.

In the landing height control step S230, the manual control unit 330 is operated to move the drone along the Z-axis. Specifically, the manual control unit 330 may be operated to guide landing of the drone 100 by moving the drone 100 to a desired height while controlling the drone 100 to hover at a certain height, ascend, or descend.

Although some embodiments have been described herein, it should be understood that various modifications, changes, alterations, and equivalent embodiments can be made by those skilled in the art without departing from the spirit and scope of the invention.

The drone landing system according to the present invention may be used for various private and commercial purposes, including tasks such as photographing a place inaccessible to humans, weather observation, sports broadcasting, investigative reporting, and unmanned delivery services, as well as for military purposes.

What is claimed is:

1. A drone landing system comprising a drone, a station, and a controller, wherein the station comprises:
a landing pad on which the drone lands;
an X/Y-axis camera disposed at a center of the landing pad, capturing a bottom-view image of the drone, and detecting a horizontal position of the drone; and
a Z-axis camera capturing a side-view image of the drone and detecting a height of the drone from the ground.

2. The drone landing system according to claim 1, wherein the controller comprises:
a display unit displaying the images captured by the X/Y-axis camera and the Z-axis camera;
an automatic control unit automatically controlling X/Y/Z-axis values of the drone based on the position and height of the drone detected by the X/Y-axis camera and the Z-axis camera; and
a manual control unit manually controlling the X/Y/Z-axis values of the drone.

3. The drone landing system according to claim 2, wherein the automatic control unit is operated automatically when the manual control unit is not in operation.

4. The drone landing system according to claim 2, wherein the drone comprises a top-view camera disposed at a lower end thereof and capturing a top-view image of the station, and the controller further comprises a top-view display unit displaying the image captured by the top-view camera.
